(19) United States
(12) Patent Application Publication
(10) Pub. No.: US 2010/0171787 A1
(43) Pub. Date: Jul. 8, 2010

(54) IMAGE RECORDING APPARATUS

(75) Inventors: Satoshi Kaiho, Kanagawa-ken (JP); Masashi Hiroki, Kanagawa-ken (JP); Atsushi Kubota, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/640,258

(22) Filed: Dec. 17, 2009

Related U.S. Application Data
(60) Provisional application No. 61/142,723, filed on Jan. 6, 2009.

(51) Int. Cl. B41J 2/015

(52) U.S. Cl. 347/21

(57) ABSTRACT

An image recording apparatus includes a carrying unit that carries a recording medium in a carrying direction, and a recording head that ejects ink to the recording medium carried by the carrying unit to perform recording. An application unit is provided on an upstream side of a carrying direction from the recording head in the carrying unit and supplies a treatment liquid to predetermined division application ranges which are divided in a direction perpendicular to the carrying direction of the recording medium depending on a size of the recording medium.

### CROSS-REFERENCE TO RELATED APPLICATION

This application is based upon and claims the benefit of priority from: U.S. Provisional Application No. 61/142,723 filed on Jan. 6, 2009, the entire contents of each of which are incorporated herein by reference.

### TECHNICAL FIELD

The present invention relates to an image recording apparatus for applying a treatment liquid to a recording medium before ink is adhered to the recording medium.

### BACKGROUND

As an image recording apparatus, there is an ink jet recording apparatus having an ink jet head. The ink jet recording apparatus ejects ink from the ink jet head to record on a recording medium while carrying the recording medium such as a paper using a carrying unit. In the ink jet recording apparatus, in order to allow the ink to be quickly fixed onto the recording medium, a treatment liquid is applied to the recording medium before the ink is ejected from the ink jet head. A technique for applying a treatment liquid to a recording medium is disclosed in, for example, JP-A-2007-301817. In JP-A-2007-301817, a technique for applying the treatment liquid to a recording medium using a pair of rollers is disclosed.

However, in JP-A-2007-301817, the treatment liquid is applied to the entire surface of one of the pair of rollers in a longitudinal direction, so that the entire surface of the one roller in the longitudinal direction functions as an application range of the treatment liquid. Accordingly, when the treatment liquid is applied to the recording medium having a width narrower than the application range of the treatment liquid the treatment liquid remains on the one roller, and the remaining treatment liquid is applied to the other roller and remains, so that the treatment liquid is wasted. When the treatment liquid remaining on the roller scatters and sticks to the housing of the apparatus, the sticking ink solidifies. When ink sticking to the housing of the apparatus solidifies, there may be a case where the ink cannot be easily removed even during cleaning.

### SUMMARY

According to a first aspect of the invention, an image recording apparatus comprises: a carrying unit that carries a recording medium; a recording head that ejects ink to the recording medium carried by the carrying unit to perform recording; and an application unit that is provided on an upstream side of a carrying direction from the recording head in the carrying unit and supplies a treatment liquid to predetermined division application ranges which are divided in a direction perpendicular to the carrying direction of the recording medium depending on the size of the recording medium.

According to a second aspect of the invention, an image recording method comprises: carrying a recording medium; supplying a treatment liquid to predetermined division application ranges which are divided in a direction perpendicular to the carrying direction of the recording medium before allowing ink to adhere to the recording medium; ejecting the ink to the recording medium applied with the treatment liquid to perform recording.

### DESCRIPTION OF THE DRAWINGS

FIG. 1 is a diagram illustrating a configuration of an image recording apparatus according to an embodiment of the invention.

FIG. 2 is a diagram illustrating a configuration of an application unit in the apparatus.

FIG. 3 is a diagram illustrating a configuration of a treatment liquid supplying system in the apparatus.

FIG. 4 is a function block diagram illustrating a controller in the apparatus.

FIG. 5 is a flowchart of application of the treatment liquid in the apparatus.

FIG. 6 is a diagram illustrating a modified example of a shape of a gap in the apparatus.

FIG. 7 is a diagram illustrating another modified example of the shape of the gap in the apparatus.

FIG. 8 is a diagram illustrating a position of the gap shown when a carriage position of a recording medium in the apparatus is close to a right end side.

### DETAILED DESCRIPTION

Hereinafter, exemplary embodiments of the invention will be described with reference to the accompanying drawings.

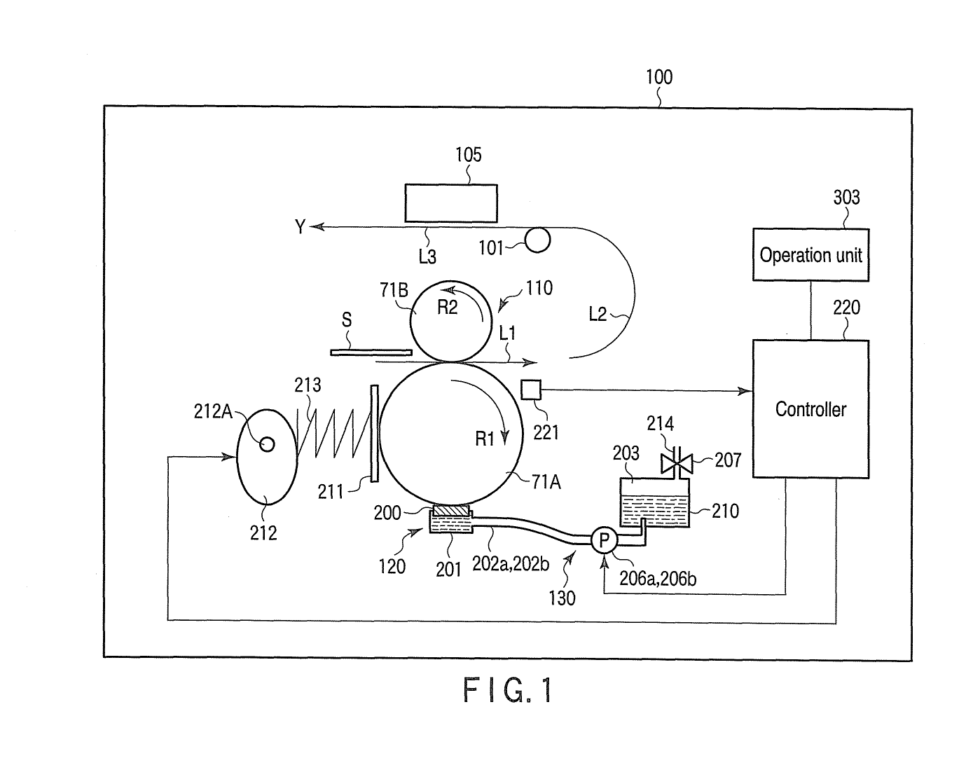

FIG. 1 is a diagram illustrating a configuration of an image recording apparatus. The image recording apparatus 100 is provided with carriage paths L1, L2, and L3. A recording medium S is carried on the carriage paths L1, L2, and L3. In the carriage path L3, a roller 101 is provided. The recording medium S may be a plurality of kinds of sheets having different sizes.

Above the carriage path L3, an ink jet head 105 is provided. The ink jet head 105 includes a plurality of ink ejection holes, and ink is ejected through each ink ejection hole. When the recording medium S is carried under the ink jet head 105, ink is ejected through each ink ejection hole of the ink jet head 105 and the ink lands on the recording medium S to form an image.

In the carriage path L1 on an upstream side of the carrying direction of the ink jet head 105, an application unit 110 for applying a treatment liquid 210 to the recording medium S is provided. The application unit 110 includes a pair of rollers 71A and 71B. The roller 71A is called an application roller. The roller 71B is called an opposed roller. The application roller 71A and the opposed roller 71B come in contact with each other and are rotated in arrow directions R1 and R2, respectively. The recording medium S is nipped between the application roller 71A and the opposed roller 71B to be carried.

The application roller 71A is provided with a contact application unit 120. The contact application unit 120 comes in contact with the application roller 71A to dividedly apply the treatment liquid 210 to the application roller 71A in a direction perpendicular to the carrying direction of the recording medium S. The contact application unit 120 includes a contact housing 201 and a porous member 200. The contact housing 201 temporarily stores the treatment liquid 210. The porous member 200 impregnates the treatment liquid 210 stored in the contact housing 201. The porous member 200 comes in surface contact with the application roller 71A to apply the treatment liquid 210 to the surface of the application roller 71A.

The treatment liquid 210 shortens the time to fix the ink on the recording medium S. The treatment liquid 210, for example, reacts with the ink on the recording medium to allow the ink to agglutinate and maintain its color fixed. The treatment liquid 210 is a polymer solution such as carboxymethylcellulose, polyvinyl alcohol, and polyvinyl acetate.

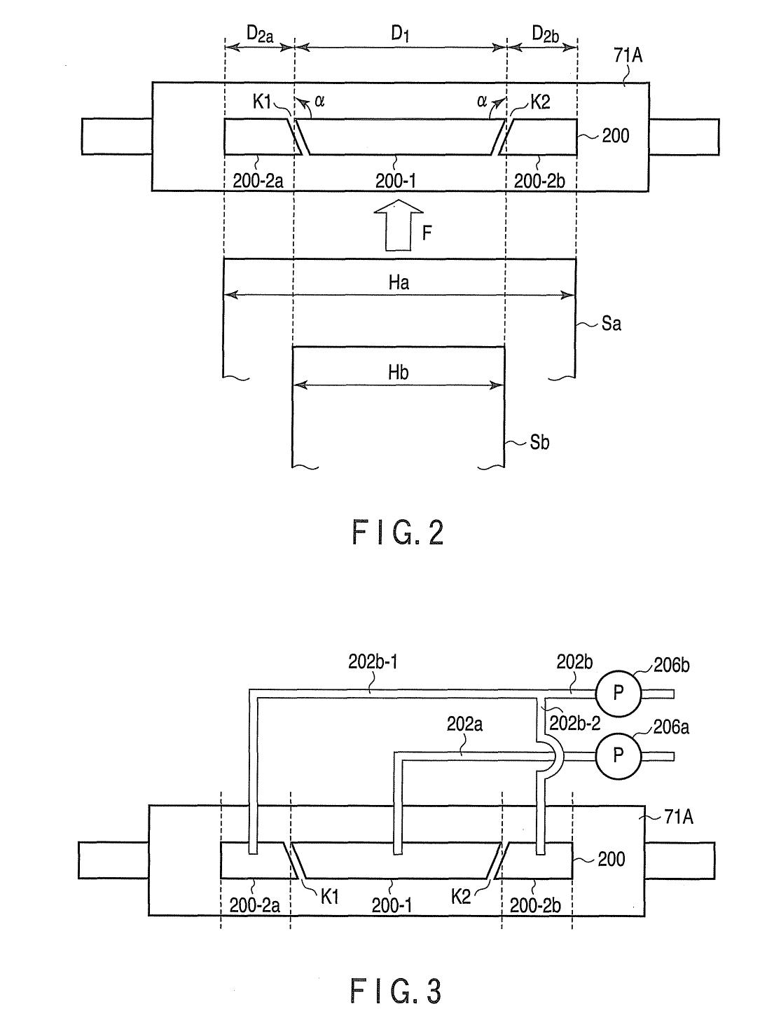

FIG. 2 illustrates a configuration of the application unit 110. Specifically, the application unit 110 is provided with a plurality of division application ranges D1, D2a, and D2b for applying the treatment liquid 210 to the recording medium S, and the treatment liquid 210 is applied to the recording medium S individually in the division application ranges D1, D2a, and D2b. The porous member 200 is divided into the division application ranges D1, D2a, and D2b. With regard to the porous member 200, a portion corresponding to the division application range D1 is referred to as a porous member 200-1, a portion corresponding to the division application range D2a is referred to as a porous member 200-2a, and a portion corresponding to the division application range D2b is referred to as a porous member 200-2b. The porous members 200-1, 200-2a, and 200-2b are divided in the direction perpendicular to the carrying direction F of the recording medium S.

A zone summing the division application ranges D1, D2a, D2b corresponds to recording medium Sa having a large width from among the recording media S having different sizes. The zone summing the division application ranges D1, D2a, and D2b corresponds to a width Ha of the recording medium Sa. The division application range D1 corresponds to a recording medium Sb having a small width. The division application range D1 corresponds to a width Hb of the recording medium Sb.

The porous members 200-1 and 200-2a, and the porous members 200-1 and 200-2b have overlapping zones in the direction perpendicular to the carrying direction F. A gap K1 is provided between the porous members 200-1 and 200-2a. A gap K2 is provided between the porous members 200-1 and 200-2b. Each of the gaps K1 and K2 has a line shape and is inclined with respect to the carrying direction F of the recording medium S. Since the division application range D1 corresponds to the recording medium Sb having a small width, positions of the gaps K1 and K2 correspond to positions of both edges of the recording medium Sb having a small width.

FIG. 3 is a diagram illustrating a configuration of a treatment liquid supplying system. The contact housing 201 is connected to a treatment liquid supplying tank 203, for example, via two supplying tubes 202a and 202b. The treatment liquid supplying tank 203 stores the treatment liquid 210. The treatment liquid supplying tank 203 is provided with an air opening tube 214. The air opening tube 214 is provided with an air opening valve 207. The first supplying tube 202a is provided with a first pump 206a. The second supplying tube 202b is provided with a second pump 206b.

One end of the first supplying tube 202a is connected to the porous member 200-1, and the other end thereof is connected to the treatment liquid supplying tank 203. The first pump 206a supplies the treatment liquid 210 stored in the treatment liquid supplying tank 203 to the porous member 200-1 through the first supplying tube 202a.

The second supplying tube 202b branches off in a first branch tube 202b-1 and a second branch tube 202b-2. The first branch tube 202b-1 is connected to the porous member 200-2a. The second branch tube 202b-2 is connected to the porous member 200-2b. The second pump 206b supplies the treatment liquid 210 stored in the treatment liquid supplying tank 203 to the porous members 200-2a and 200-2b through the first and second branch tubes 202b-1 and 202b-2, respectively, from the second supplying tube 202b.

A controller 220 drives the first pump 206a or the first and second pumps 206a and 206b depending on the size of the recording medium S and selects the division application range D1 or the division application ranges D2a and D2b to be applied with the treatment liquid 210.

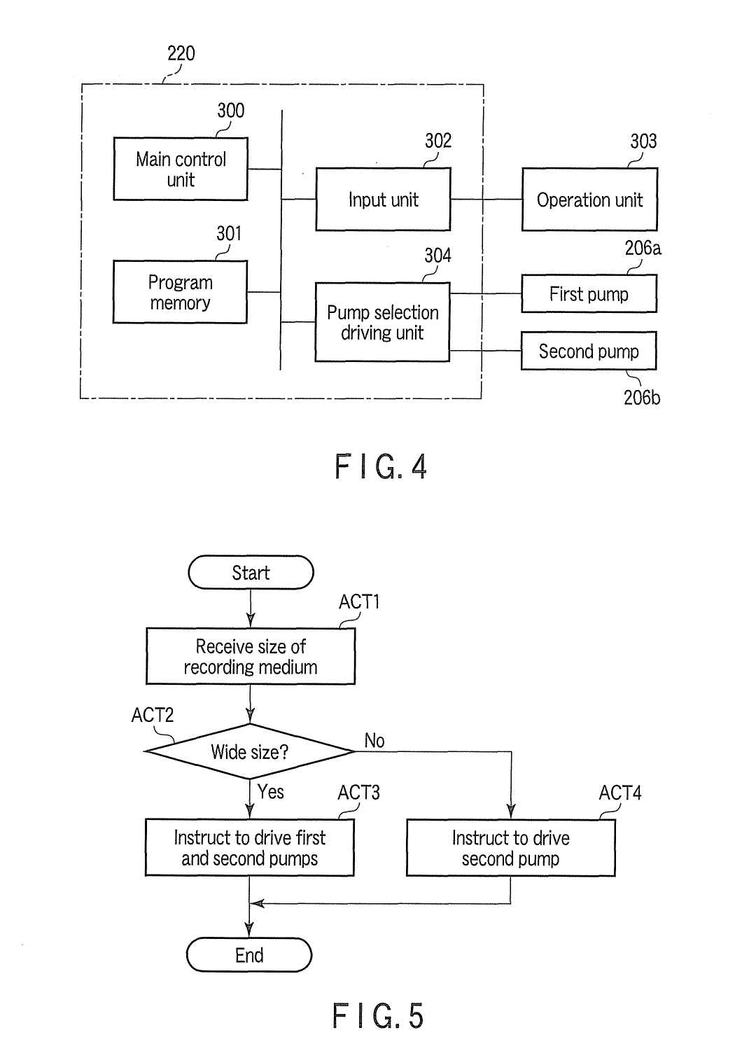

FIG. 4 is a function block diagram illustrating the controller 220. The controller 220 includes a main control unit 300 configured as a CPU or the like. The main control unit 300 is connected to a program memory 301 and an input unit 302. The program memory 301 stores a treatment liquid application program in advance. When the ink is to be ejected to the carried recording medium S to perform recording, the treatment liquid application program allows the application unit 110 to supply the treatment liquid 210 that shortens the time to fix the ink to the recording medium S, to the predetermined division application ranges which are divided in the direction perpendicular to the carrying direction F of the recording medium S depending on the size of the recording medium S. Specifically, the treatment liquid application program determines the size of the recording medium S, and if the recording medium S is the recording medium Sa having a wide size, drives the first and second pumps 206a and 206b. If the recording medium S is the recording medium Sb having a narrow size, the treatment liquid application program drives only the first pump 206a.

The input unit 302 is connected to an operation unit 303. The operation unit 303 selects the size of the recording medium S according to an operation of a user, and particularly, here, selects the recording medium Sa having a wide size or the recording medium Sb having a narrow size. The operation unit 303 is configured as, for example, a keyboard, a size selection button, or a touch panel.

The main control unit 300 has a pump selection driving unit 304 by executing the treatment liquid application program stored in the program memory 301. The pump selection driving unit 304 is connected to the first and second pumps 206a and 206b. The pump selection driving unit 304 receives the size of the recording medium S selected by the operation for the operation unit 303, if the recording medium S is the recording medium Sa having a wide size, drives the first and second pumps 206a and 206b, and if the recording medium S is the recording medium Sb having a narrow size, drives only the first pump 206a.

A cam 212 is provided to rotate around a shaft core 212A. The shaft core 212A is connected to a motor. The cam 212 has a restriction blade 211 with a spring 213 interposed therebetween. The restriction blade 211 comes in contact with the application roller 71A. A temperature sensor 221 detects a temperature of the vicinity of the recording medium S. The controller 220 determines a pressing force needed for the restriction blade 211 on the basis of temperature information detected by the temperature sensor 221 so as to control rotating the cam 212. Accordingly, an application amount of the treatment liquid 210 to be applied to the application roller 71A is restricted by the restriction blade 211.

Next, an operation of applying the treatment liquid by the apparatus having the above-mentioned configuration will be described with reference to the flowchart of application of the treatment liquid shown in FIG. 5.

When the size of the recording medium S, for example, the wide-sized recording medium Sa having an A3 size is selected by the user using the operation unit 303, the pump selection driving unit 304 receives the size of the recording medium S selected by the operation of the operation unit 303 (Act 1).

Next, the pump selection driving unit 304 determines whether or not the size of the recording medium S corresponds to a recording medium to which the treatment liquid 210 is to be applied by the entire width of the porous member 200 (Act 2). That is, it is determined whether or not the size corresponds to a recording medium to which the treatment liquid 210 is to be applied using all the porous members 200-1, 200-2a, and 200-2b.

As a determination result, when it is determined that the size corresponds to the recording medium to which the treatment liquid 210 is to be applied using the entire width of the porous member 200 (Yes in Act 2), the pump selection driving unit 304 instructs the first and second pumps 206a and 206b to operate (Act 3). The first pump 206a supplies the treatment liquid 210 stored in the treatment liquid supplying tank 203 to the porous member 200-1 through the first supplying tube 202a. As described above, the second pump 206b supplies the treatment liquid 210 stored in the treatment liquid supplying tank 203 to the porous members 200-2a and 200-2b through the first and second branch tubes 202b-1 and 202b-2 from the second supplying tube 202b. The treatment liquid 210 is supplied to all the porous members 200-1, 200-2a, and 200-2b. The porous members 200-1, 200-2a, and 200-2b impregnate the treatment liquid 210.

The application roller 71A and the opposed roller 71B come in contact with each other and are rotated in arrow directions R1 and R2, respectively. In addition, the application roller 71A comes in contact with the porous members 200-1, 200-2a, and 200-2b while rotating in the arrow direction R1. Since the porous members 200-1, 200-2a, and 200-2b impregnate the treatment liquid 210, a surface of the application roller 71A is applied with the treatment liquid 210 by the porous members 200-1, 200-2a, and 200-2b.

A zone applied with the treatment liquid 210 on the surface of the application roller 71A is a zone summing the division application ranges D1, D2a, and D2b corresponding to the width Ha of the wide-sized recording medium Sa as illustrated in FIG. 2.

When the recording medium Sa having a wide size is carried on the carriage path L1, the recording medium Sa is nipped and carried between the application roller 71A and the opposed roller 71B. Here, the recording medium Sa is applied with the treatment liquid 210 by the application roller 71A over the division application ranges D1, D2a, and D2b shown in FIG. 2. Since the gaps K1 and K2 between the division application ranges D1, D2a, and D2b are inclined with respect to the carrying direction F, it is possible to prevent a particular area from not being applied with the treatment liquid in the carrying direction F of the recording medium Sa.

Thereafter, the recording medium Sa applied with the treatment liquid 210 is carried on the carriage paths L2 and L3 so as to be carried under the ink jet head 105. A surface of the recording medium Sa carried under the ink jet head 105, which is applied with the treatment liquid 210, faces the ink jet head 105. The ink jet head 105 ejects ink from each ink ejection hole. The ink lands on the recording medium S to form an image. Here, since the recording medium Sa is applied with the treatment liquid 210, the ink is fixed thereto quickly.

When it is determined that the size corresponds to a recording medium to which the treatment liquid 210 is applied using a part of the porous member 200 (No in Act 2), the pump selection driving unit 304 drives only the first pump 206a (Act 4). The first pump 206a supplies the treatment liquid 210 stored in the treatment liquid supplying tank 203 to the porous member 200-1 through the first supplying tube 202a. The treatment liquid 210 is supplied to the porous member 200-1. The porous member 200-1 impregnates the treatment liquid 210.

The application roller 71A and the opposed roller 71B come in contact with each other and are rotated in the arrow directions R1 and R2. In addition, the application roller 71A comes in contact with the porous members 200-1, 200-2a, and 200-2b while rotating in the arrow direction R1. Only the porous member 200-1 impregnates the treatment liquid 210. Accordingly, a surface of the application roller 71A is applied with the treatment liquid 210 only by the porous member 200-1.

A zone on the surface of the application roller 71A, which is applied with the treatment liquid 210 is only the division application range D1 corresponding to a width Hb of the recording medium Sb having a shorter size (narrower size) in the direction perpendicular to the carriage direction than that of the recording medium Sa as illustrated in FIG. 2. The size shorter than that of the recording medium Sa in the direction perpendicular to the carrying direction is, for example, A4 size.

When the recording medium Sb having the narrow size is carried under the carriage path L1, the recording medium Sb is nipped and carried between the application roller 71A and the opposed roller 71B. Here, the treatment liquid 210 is applied to the recording medium Sb by the application roller 71A only on the division application range D1 shown in FIG. 2.

Thereafter, the recording medium Sb applied with the treatment liquid 210 is carried on the carriage paths L2 and L3 to be carried under the ink jet head 105, on which the ink lands from the ink jet head 105. Since the recording medium S is applied with the treatment liquid 210, the ink is fixed thereto quickly.

According to this embodiment described above, when recording is to be performed on the recording medium S by ejecting ink, before allowing the ink to adhere to the recording medium S, the recording medium S is applied with the treatment liquid 210 dividedly depending on the size of the recording medium S. Accordingly, for example, if the recording medium S is the recording medium Sa having a wide size, a zone applied with the treatment liquid 210 is the division application ranges D1, D2a, and D2b corresponding to the width Ha of the recording medium Sa as illustrated in FIG. 2. If the recording medium S is the recording medium Sb having a narrow size, a zone applied with the treatment liquid 210 is only the division application range D1. As a result, even when the size of the recording medium S is different, the treatment liquid 210 does not remain on the application roller 71A, so that the treatment liquid 210 is not wasted. Since the treatment liquid 210 does not remain on the application roller 71A, the treatment liquid 210 does not scatter, and an effort for cleaning can be reduced. In addition, since the inclination angles of the gaps K1 and K2 are obtuse angles with respect to the carrying direction F, a portion that is not applied with the treatment liquid in the direction perpendicular to the carrying direction F can be suppressed to be small.

Next, modified examples of shapes of the gaps K1 and K2 are described.

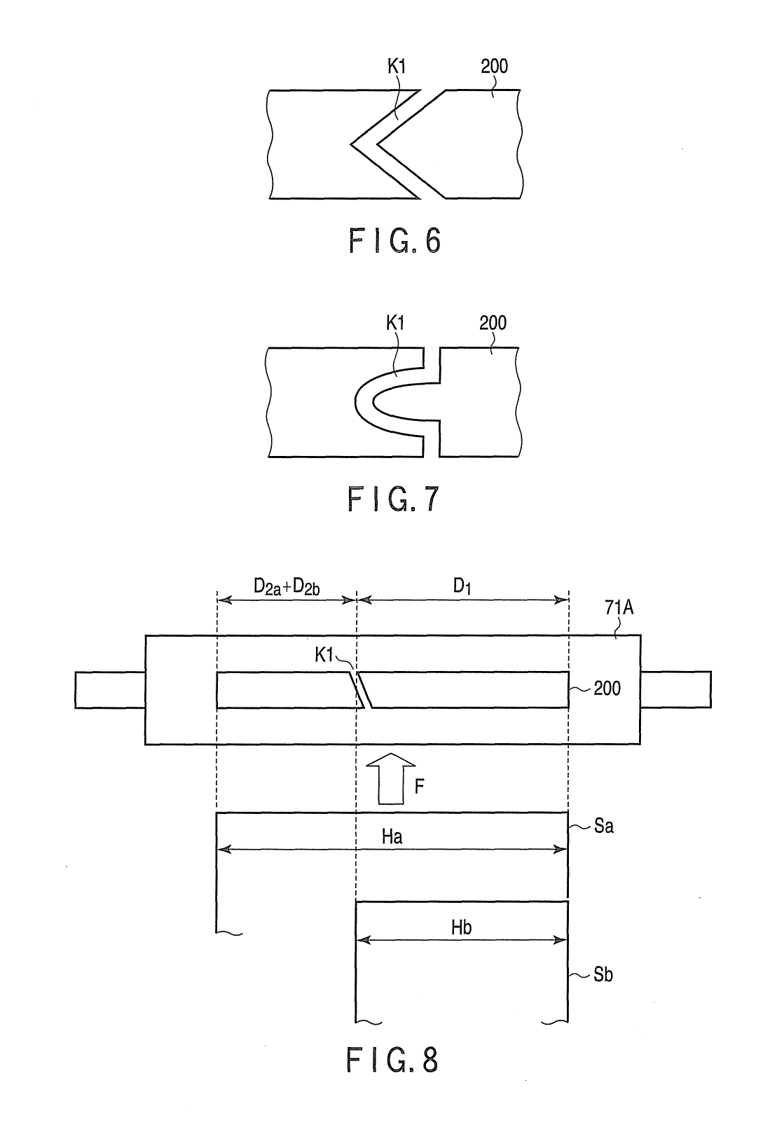

The gap K1 may have a V shape in a longitudinal direction of the porous member as illustrated in FIG. 6, or may have a U shape in the longitudinal direction of the porous member as illustrated in FIG. 7. The gaps K1 and K2 are inclined with respect to the carrying direction F of the recording medium S by the V or U shape. The inclination angles of the gaps K1 and K2 are obtuse angles with respect to the carrying direction F.

According to the embodiment, the center portion of the application roller 71A is determined as a carriage position of the recording medium S. However, as illustrated in FIG. 8, the carriage position of the recording medium S may be, for example, close to a right end side. With regard to this carriage position, the gap K1 is provided at a position distant from the right end side by the division application range D1.

The embodiment described above corresponds to two types of sizes, that is, the sizes of the wide-sized recording medium Sa and the narrow-sized recording medium Sb. However, the embodiment is not limited thereto, and may correspond to recording media S having a variety of sizes. When the embodiment corresponds to the recording media S having a variety of sizes, the gaps K1 and K2 and the like are provided at positions corresponding to each of the sizes of the recording media S.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image recording apparatus comprising:
a carrying unit that carries a recording medium in a carrying direction;
a recording head that ejects ink to the recording medium carried by the carrying unit to perform recording; and
an application unit that is provided on an upstream side of the carrying direction from the recording head in the carrying unit and supplies a treatment liquid to predetermined division application ranges which are divided in a direction perpendicular to the carrying direction of the recording medium depending on a size of the recording medium.

2. The apparatus according to claim 1,
wherein the application unit supplies the treatment liquid independently to the division application ranges.

3. The apparatus according to claim 1,
wherein a length in the perpendicular direction of the division application range is a length of the recording medium in the perpendicular direction.

4. The apparatus according to claim 2,
wherein the division application ranges have overlapping zones in the perpendicular direction.

5. The apparatus according to claim 2,
wherein a gap is provided between the division application ranges, and
the gap is inclined with respect to the carrying direction of the recording medium.

6. The apparatus according to claim 5,
wherein an inclination angle of the gap is an obtuse angle with respect to the carrying direction of the recording medium.

7. The apparatus according to claim 5,
wherein the gap is provided to correspond to one or both positions of both side end portions of the recording medium.

8. The apparatus according to claim 5, wherein the gap has a linear shape.

9. The apparatus according to claim 5, wherein the gap has a V shape.

10. The apparatus according to claim 5, wherein the gap has a U shape.

11. The apparatus according to claim 3,
wherein the application unit includes:
an application roller that applies the treatment liquid to the recording medium;
a contact application unit which comes in contact with the application roller to dividedly apply the treatment liquid to the application roller in the direction perpendicular to the carrying direction of the recording medium.

12. The apparatus according to claim 11,
wherein the contact application unit includes porous members that impregnate the treatment liquid and come in contact with the application roller.

13. The apparatus according to claim 12, further comprising:
a treatment liquid supplying unit that supplies the treatment liquid independently to the porous members corresponding to the division application ranges.

14. The apparatus according to claim 13,
wherein the treatment liquid supplying unit includes:
a plurality of supplying tubes that are connected to the respective porous members; and
a plurality of pumps that are connected to the respective supplying tubes to supply the treatment liquid to the respective porous members through the supplying tubes.

15. The apparatus according to claim 2, further comprising:
an application roller that applies the treatment liquid to the recording medium;
a plurality of porous members that impregnate the treatment liquid and are divided according to division application ranges, and each of which comes in contact with the application roller to apply the treatment liquid to the application roller;
a plurality of supplying tubes that are connected to the respective porous members;
a plurality of pumps that are connected to the respective supplying tubes to supply the treatment liquid to the respective porous members through the supplying tubes; and
a control unit that selects at least one division application range from the division application ranges so as to be applied with the treatment liquid and drives the pumps to select at least one division application range so as to be applied with the preprocessing solution.

16. The apparatus according to claim 1,
wherein the treatment liquid shortens a time to fix the ink to the recording medium.

17. An image recording apparatus comprising:
carrying means that carries a recording medium in a carrying direction;
recording means that ejects ink to the recording medium carried by the carrying unit to perform recording;
application means that is provided on an upstream side of a carrying direction from the recording unit in the carrying unit and supplies a treatment liquid to predetermined division application ranges which are divided in a direction perpendicular to the carrying direction of the recording medium depending on a size of the recording medium.

18. The apparatus according to claim 17,
wherein the application means supplies the treatment liquid independently to the division application ranges.

19. An image recording method comprising:
carrying a recording medium;
supplying a treatment liquid to predetermined division application ranges which are divided in a direction perpendicular to a carrying direction of the recording medium before allowing ink to adhere to the recording medium;
ejecting the ink to the recording medium applied with the treatment liquid to perform recording.

20. The method according to claim 19,
wherein the treatment liquid is independently supplied to the division application ranges.
